(19) United States
(12) Patent Application Publication
(10) Pub. No.: US 2016/0057687 A1
(43) Pub. Date: Feb. 25, 2016

(54) INTER/INTRA RADIO ACCESS TECHNOLOGY MOBILITY AND USER-PLANE SPLIT MEASUREMENT CONFIGURATION

(71) Applicant: QUALCOMM Incorporated, San Diego, CA (US)

(72) Inventors: Gavin Bernard HORN, La Jolla, CA (US); Nathan Edward TENNY, Poway, CA (US)

(21) Appl. No.: 14/599,088

(22) Filed: Jan. 16, 2015

Related U.S. Application Data
(60) Provisional application No. 62/039,216, filed on Aug. 19, 2014.

(51) Int. Cl. H04W 36/30; H04W 28/10; H04W 76/02; H04W 36/08; H04W 24/10

(52) U.S. Cl. CPC H04W 36/30; H04W 36/08; H04W 24/10; H04W 76/02; H04W 28/10; H04W 88/06

(57) ABSTRACT

Certain aspects of the present disclosure relate to methods and apparatus for wireless communication, and more particularly, to methods and apparatus for inter/intra RAT mobility and U-plane split measurement configuration based on context and service awareness. For example, in certain aspects, a mobile device may manage at least one data flow between a core network and the mobile device by identifying at least one constraint on selection of an aggregation point for the data flow. The constraint may be based on at least one of a context for the mobile device or a service associated with the data flow. The mobile device may send a report to a first node based on the at least one identified constraint and receive a configuration request to establish a connection with a second node based on the report.

The present application claims priority to provisional U.S. Application Ser. No. 62/039,216, entitled “INTER/INTRA RADIO ACCESS TECHNOLOGY MOBILITY AND USER-PLANE SPLIT MEASUREMENT CONFIGURATION,” filed Aug. 19, 2014, which is assigned to the assignee of the present application and hereby expressly incorporated by reference herein in its entirety.

### FIELD

The present disclosure relates generally to wireless communication, and more particularly, to methods and apparatus for routing data between a mobile device and core network using different communication links.

### BACKGROUND

Wireless communication systems are being developed with the goal of enabling new services and devices, which will offer new user experiences. One approach to achieve this is to leverage multiple existing radio access technologies (RATs), for example, using a combination of features from wireless wide area networks (e.g., 3G and LTE) and wireless local area networks (e.g., based on WiFi and millimeter wave (mmW). This approach may help speed development and take advantage of different benefits provided by the different RATs.

One challenge with a system that utilizes multiple RATs is how to optimally route data between a core network and a user, given the different paths offered by the different RATs.

### SUMMARY

Certain aspects of the present disclosure provide a method of wireless communication by a mobile device for managing at least one of a data flow between a core network and the mobile device. The method generally includes identifying at least one constraint on selection of an aggregation point for the data flow wherein the constraint is based on at least one of a context for the mobile device or a service associated with the data flow, sending a report to a first node based on the at least one identified constraint, and receiving a configuration request to establish a connection with a second node based on the report.

Certain aspects of the present disclosure provide a method for wireless communication by a first node for managing at least one data flow between a core network and a mobile device. The method generally includes selecting an aggregation point or type of aggregation for the data flow based on at least one constraint, wherein the constraint is based on at least one of a context for the mobile device or a service associated with the data flow, identifying at least one second node for delivering at least a portion of the data flow to the mobile device based on the selection, evaluating a capability of the second node to deliver the at least one data flow to the mobile device; and, directing the at least one data flow to be routed to the second node.

Aspects also provide various apparatus, systems, computer program products, and processing systems for performing the operations described above.

### BRIEF DESCRIPTION OF THE DRAWINGS

FIG. 1 illustrates an example wireless environment, in accordance with certain aspects of the present disclosure.

FIGS. 2A and 2B illustrate example protocol layers for control plane and user plane routing, in accordance with certain aspects of the present disclosure.

FIG. 3 illustrates an example multi-connectivity protocol stack, in accordance with aspects of the present disclosure.

FIG. 4 illustrates example offload configuration, in accordance with aspects of the present disclosure.

FIG. 5 illustrates example user plane (U-plane) splitting configurations, in accordance with aspects of the present disclosure.

FIG. 6 illustrates example control plane (C-plane) logical architecture options, in accordance with aspects of the present disclosure.

FIG. 7 illustrates example control place (C-plane) Non-Access Stratum (NAS) logical architecture options, in accordance with aspects of the present disclosure.

FIG. 8 illustrates an example call flow diagram of a mobile device, a master base station, and a secondary base station, in accordance with aspects of the present disclosure.

FIG. 9 illustrates example operations for managing a data flow, in accordance with aspects of the present disclosure.

FIG. 10 illustrates example operations for routing a data flow, in accordance with aspects of the present disclosure.

FIG. 11 illustrates a block diagram of an example mobile device, in accordance with aspects of the present disclosure.

FIG. 12 illustrates a block diagram of an example base station, in accordance with aspects of the present disclosure.

### DETAILED DESCRIPTION

Aspects of the present disclosure provide techniques that may be used to route data between a core network and a mobile device connected via multiple radio access technologies (RATs). In some cases, an entity making routing decisions (regarding aggregation points and user plane data split options for a data flow) and mobility decisions may consider particular services of a given data flow. Based on such considerations, the data flow may be routed via one or multiple RATs and the mobile device may be configured to report information useful in making the data flow.

Aspects of the present disclosure may be applied to a wide variety of different types of mobile devices communicating via a wide variety of different RATs. Different terminology may be used to refer to mobile devices. For example, in some cases depending on the RAT(s) supported thereby, a mobile device may be referred to as a wireless device, user terminal (UT), access terminal (AT), user equipment (UE), station, mobile station, wireless station, wireless node, or the like. Similarly, different terminology may be used to refer to a base station that provides services to a mobile device, such as access to a core network. For example, in some cases depending on the RAT(s) supported thereby, a base station may be referred to as an access point (AP), a node B, an enhanced Node B (eNodeB), or simply an eNB.

In certain examples that follow, a mobile device is referred to as a UE and base stations are referred to as eNBs. Such references are not meant to limit aspects of the present disclosure to any particular RAT or RATs, but are merely to help describe illustrative examples meant to facilitate understanding.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

### An Example Wireless Environment

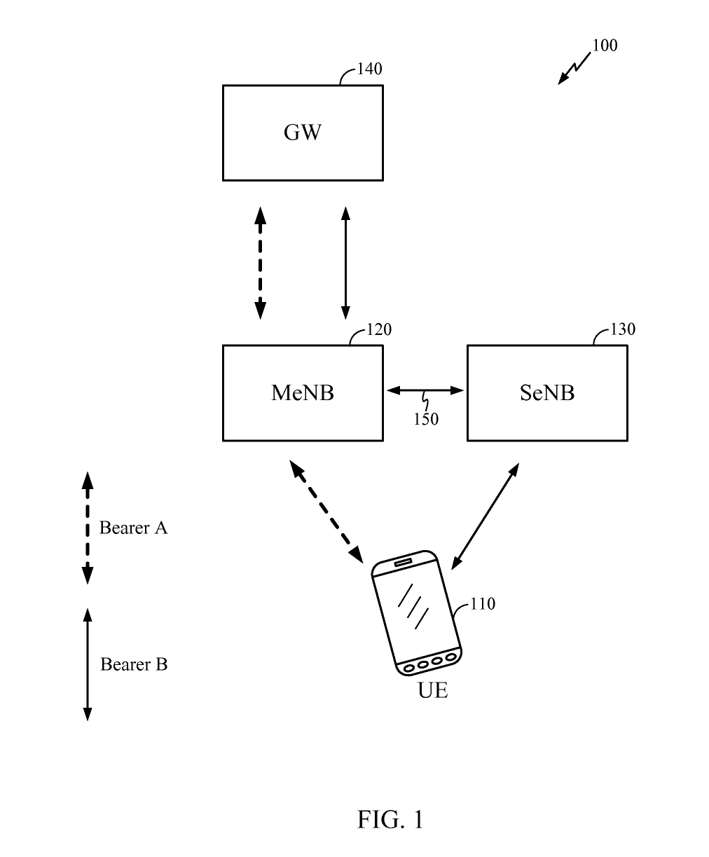

FIG. 1 illustrates an example wireless environment 100, in which aspects of the present disclosure may be utilized to manage data flows between a core network and a wireless device, such as UE 110.

As illustrated, UE 110 may be capable of communicating with multiple base stations, such as a master eNodeB (MeNB) 120 and a secondary eNodeB (SeNB) 130. MeNB 120 and SeNB 130 may communicate via the same RAT or different RATs. For example, MeNB 120 may communicate via a wireless wide area network (WWAN) protocol (e.g. LTE) while SeNB 130 may communicate via a wireless local area network (WLAN) protocol (e.g., WiFi).

As used herein, the term MeNB generally refers to an eNB that terminates an S1-MME (Mobility Management Entity) control plane for the UE, while the term SeNB generally refers to an eNB serving the UE that is not the MeNB. An S1 connection may be used by the MeNB or SeNB to communicate with the core network (CN), for example via a CN gateway (GW) 140. For example, the S1 interface may include an S1-U interface, which serves the data plane between the MeNB or SeNB and the CN GW, and an S1-MME, which serves the control plane.

In certain aspects, the MeNB may be connected to one or more SeNBs to serve a UE via multi-connectivity. The MeNB and SeNB may communicate with one another via a backhaul connection 150 (e.g., an X2 connection). The backhaul connection need not be direct but may be routed through one or more intermediate nodes (e.g., an MME, an interworking gateway function, or a router). The number of SeNBs may be limited, depending on the capabilities of the UE. The MeNB may coordinate mobility and user-plane (U-plane) split procedures within the corresponding operator network. The MeNB may be considered as “access agnostic,” meaning it may support any type of RAT both to serve the UE and also for managing the UE configuration of a U-plane split with one or more SeNBs. For example, an MeNB may utilize a common U-plane anchored in the operator's core network (CN) in order to enable procedures to manage the U-plane split via multiple RATs, as described herein.

The SeNB may be utilized as a source of supplemental capacity for the MeNB and may also use a different RAT (from the RAT of the MeNB) to serve the UE. According to aspects of the present disclosure, an SeNB is limited to serving a UE and in most cases may not be used to control the UE configuration of the U-plane split. Having the SeNB as a supplemental capacity for the MeNB may provide an opportunistic and energy efficient operation, which may be initiated by the UE's user or the network operator.

The SeNB may be loosely or tightly coupled with the MeNB, depending on backhaul bandwidth capabilities and latency requirements. For example, an SeNB that is considered tightly coupled with an MeNB may have the SeNB's connection to the UE substantially managed by the MeNB. On the other hand, an SeNB that is considered loosely coupled with an MeNB may leave the SeNB's connection to the UE under the control of the SeNB subject to, for example, general requirements such as Quality of Service (QoS) from the MeNB. For example, an SeNB with a high-capacity and low-latency backhaul link to an MeNB may be tightly coupled with the operations of the MeNB. The SeNB may be used as a supplemental downlink (SDL) or as an additional cell for both uplink (UL) and DL. In some cases, the SeNB may be used to help achieve supplemental mobility robustness of the MeNB, for example, for mission critical applications. For example, the SeNB may provide a redundant path for delivery of critical information and may also provide a fast failover (to the SeNB) in the event the MeNB experiences a radio link failure (RLF).

Multi-connectivity (MC) generally refers to a mode of operation wherein a UE is connected (e.g., radio resource control (RRC) connected) to an MeNB and at least one SeNB, as illustrated in FIG. 1. FIG. 1 shows a specific example of MC, with two different eNBs, that may be referred to as dual connectivity (DC). In MC, a group of serving cells associated with the MeNB, including a primary cell (PCell) and optionally one or more secondary cells (SCells), may be referred to as a master cell group (MCG). Similarly, a group of serving cells associated with the SeNB may be referred to as a secondary cell group (SCG).

Certain aspects of the present disclosure present MC procedures which include procedures to change (add to an SCG, remove from an SCG, or modify the configuration of) one or more cells of an SeNB, while maintaining a current MeNB. As will be described in greater detail below, MC procedures may include various options for offloading data communications using MC, for example, at the packet level, bearer level, or access packet network (APN) level.

MC procedures may also include handover procedures to change the MeNB, e.g., by transferring the functionality of the MeNB for a UE's MC configuration to another eNB, as well as additional aggregation procedures. The aggregation procedures may include procedures to change (add, remove, or modify) a set of one or more secondary component carriers (SCC) of the MeNB and/or an SeNB. In some cases, aggregation may imply a primary component carrier (PCC) controlling one or more secondary component carrier (SCCs) with a common media access control (MAC) layer.

The present disclosure provides various options for aggregation and U-plane splitting, such as aggregation within a same node, (e.g., carrier aggregation) and U-plane splitting across nodes via the radio access network (RAN). For example, for multi-connectivity, a data flow may be split on a per-packet basis or split on a per-bearer basis (e.g., split over the X2 interface instead of the S1 interface).

In some cases, the U-plane may also be split across nodes via the CN, for example, via a bearer-split using multi-connectivity. That is, a CN sending data via multiple bearers e.g., Bearer A and Bearer B in FIG. 1, to a UE may use multi-connectivity to assign one bearer to an MeNB and a second bearer to an SeNB, and send data packets to the MeNB and SeNB based on which bearer each packet is traversing.

Another option for aggregation and U-plane splitting is non-seamless offload, which may include offloading to another operator (if allowed), for example, if session continuity is not necessary. This may be considered equivalent to per-packet splitting if multi-path transmission control protocol (MP-TCP) is available, otherwise the split may occur at the Internet protocol (IP) flow level. Another option is multi-casting (e.g., bi-casting) traffic wherein, for example, each packet is served by both the MeNB and SeNB for greater reliability.

Aspects of the present disclosure describe several possible considerations for making aggregation and U-plane split decisions. In some cases, aggregation in a node may utilize a common MAC layer. The aggregated PCC and SCC(s) may have compatible control channels and timing requirements, but may not require a separate UL channel (e.g., for acknowledging transmissions) for the SCC(s).

In some cases, per-packet U-plane splitting performance may be optimized to support multiple access links across RATs with different latencies and link error rates. Similarly, per-packet U-plane splitting performance may be optimized across licensed, shared, and/or unlicensed bands, and for cells sharing the same carrier and/or for cells on separate carriers.

### Example Protocol Stack Configurations for Aggregation and User Plane Splitting

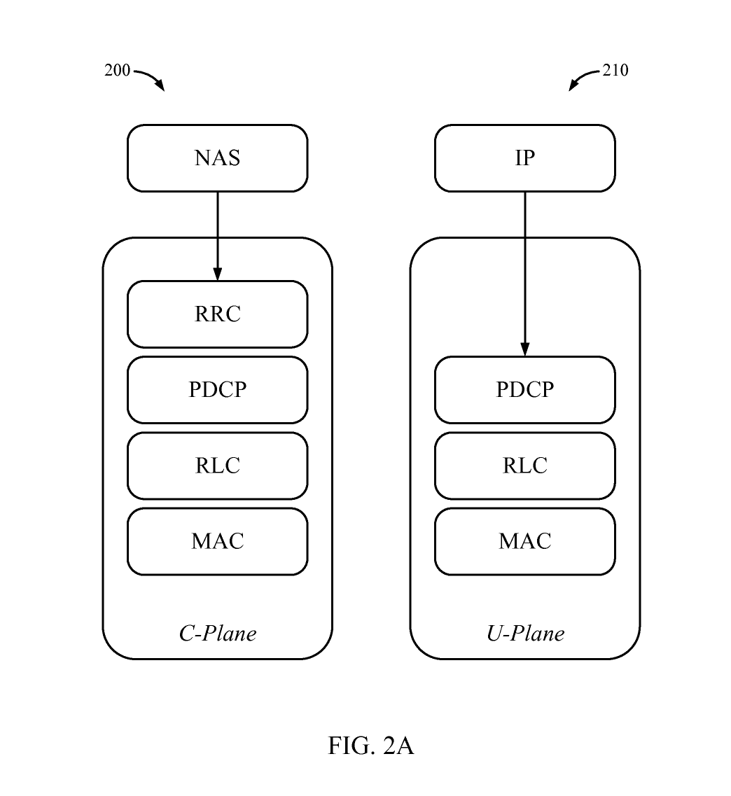

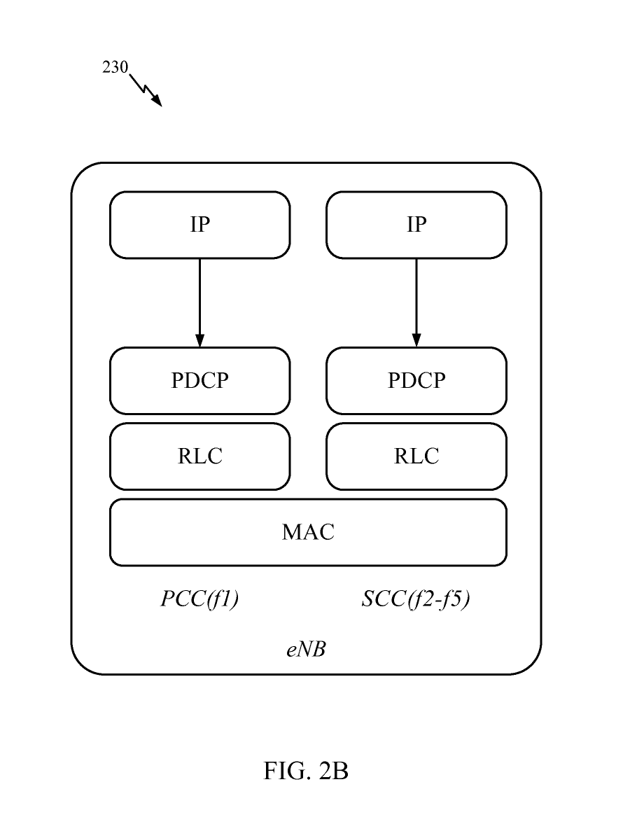

Different options for U-plane splitting may be described with reference to wireless communication protocol stacks, such as the Long Term Evolution (LTE) C-plane stack 200 and U-plane stack 210 shown in FIG. 2A. In the C-plane, a non-access stratum (NAS) message is received by the radio resource control (RRC) layer and is passed down to the packet data convergence protocol (PDCP) layer, radio link control (RLC) layer and media access control (MAC) layer. In the U-plane, an IP packet is received by the PDCP layer and passed down to the RLC layer and MAC layer.

As mentioned above, different levels of U-plane splitting are possible, with different corresponding considerations when making routing decisions. For example, for a per-bearer or per IP flow split, a decision of where to serve each IP packet may be based on a Traffic Flow Template (TFT) associated with the bearer or IP flow. In this case, a common PDCP layer or RLC layer may not be required between different serving nodes as there is no reordering issue between serving nodes, since all the IP packets for a flow are routed through the same serving node. That is, because the packets are routed based on which bearer or flow the packets belong to, all of the packets for any given flow arrive at the UE from one serving node, and the receiving UE can determine the correct order of the packets from indicators supplied by the node.

When packets of a flow arrive from multiple serving nodes, the indicators (e.g., sequence numbers) used by the nodes may conflict, and the receiving UE cannot determine the proper order of the packets. For example, in the case of a per-bearer or per-IP-flow split, the split may occur at a serving gateway (SGW) via an S1 interface (e.g., for MC) or at a packet data network gateway (PGW) or home agent (HA) (e.g., for WLAN interworking), resulting in packets for the bearer or IP flow being delivered to multiple serving nodes which may then assign their own indicators to the packets without coordination. For the UE to reassemble the packets in the correct order, some coordination or additional information must be provided. As an example, the node at which the split occurs may provide packet identifiers that determine a sequence of packets for the bearer, irrespective of the serving node that delivers a particular packet. A RAN-only solution may also be possible via an interface between serving nodes, e.g., an X2 interface.

For U-plane splitting on a per-packet basis, a common PDCP layer (for MC) across serving nodes may be utilized to reorder the packets in a flow, while RLC reordering may also be possible. In the case of U-plane splitting on a per-packet basis, the per-packet decision of where to serve each PDCP packet may be based on scheduling requirements (e.g., bandwidth available at transmission times) on each eNB. According to certain aspects of the present disclosure, flow control may be defined between the MeNB and SeNB to allow the MeNB and SeNB to make the per-packet determinations of where to serve each PDCP packet.

In certain systems (e.g., current LTE), mobility and aggregation are generally based on the principle that a UE is served by a single serving eNB on the C-plane, meaning that RRC and NAS signaling are only sent to the UE via a single eNB. In some versions of these systems, a UE may also be served by up to 2 serving eNBs on the U-plane, and by multiple (e.g., up to 5 in Release 12 of LTE) cells across the 2 serving eNBs.

FIG. 2B illustrates an example configuration 230 of carrier aggregation for the U-plane protocol stack for an eNB having a primary component carrier (PCC) f1 and secondary component carriers (SCCs) f2-f5 in current wireless communication systems (e.g., LTE Rel-10). In carrier aggregation (CA), reconfiguration, addition, and removal of secondary cells (SCells) within a single serving eNB may be performed by the RRC function. The primary cell (PCell), belonging to the same eNB, is used for transmission of physical uplink control channels (PUCCH), and NAS information is taken from the PCell. Cross-carrier scheduling, via a carrier indicator field (CIF), allows the physical downlink control channel (PDCCH) of a serving cell (e.g., the PCell) to schedule resources on another serving cell. Unlike SCells, it may not be possible to remove or deactivate a PCell.

A PCell serving a UE may be changed with a handover procedure (i.e. with a security key change and RACH procedure). For handover from one LTE PCell to another LTE PCell, RRC functions can also add, remove, or reconfigure SCells for usage with the target PCell. As a result, the UE may be able to handover (HO) to a target eNB and continue CA without the re-establishing connections to SCells serving the UE. Re-establishment of connections by the UE is triggered when the PCell serving the UE experiences RLF, but not when SCells experience RLF. UEs operating in a CA system generally receive data faster due to the increased available bandwidth in a CA system than in a system without CA.

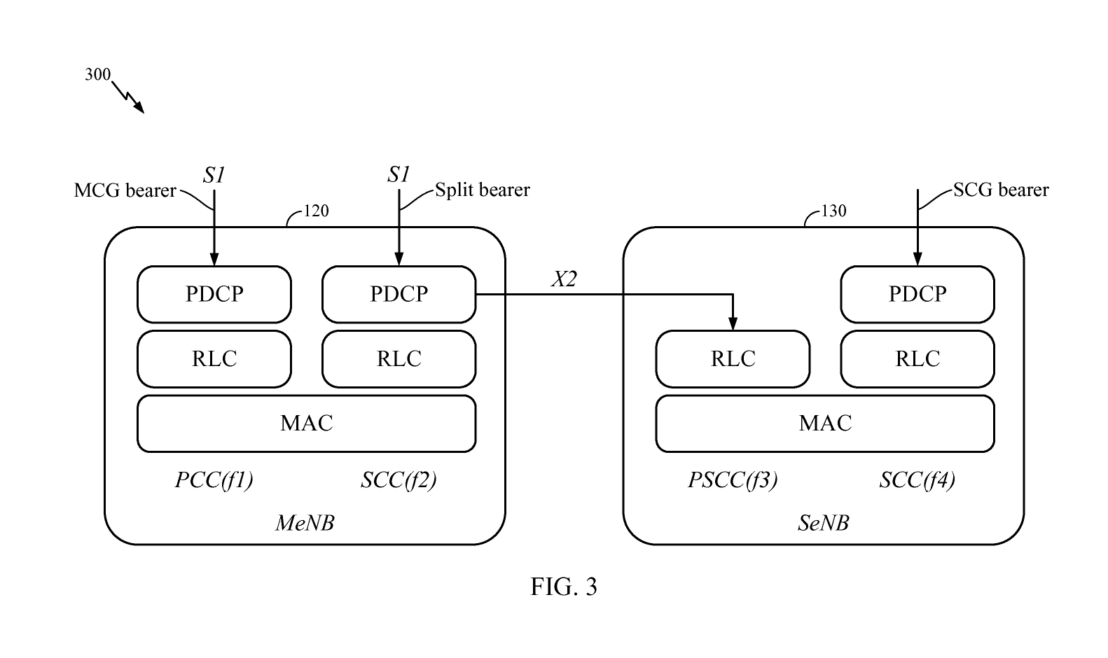

FIG. 3 illustrates an example configuration 300 of a dual connectivity protocol stack linking (via an X2 connection) an MeNB and an SeNB. The protocol stack for a particular bearer generally depends on how that bearer is setup. For example, various alternative types of bearer exist: MCG bearers, split bearers, and SCG bearers. For MCG bearers (e.g., the left bearer in FIG. 3), the MeNB is U-plane connected to the S-GW via an S1-U interface and the SeNB is not involved in the transport of user plane data for this bearer. For split bearers (e.g., the middle bearer in FIG. 3), the MeNB is U-plane connected to the S-GW via an S1-U interface and, in addition, the MeNB and the SeNB are interconnected via an X2-U interface, allowing both the MeNB and the SeNB to deliver U-plane data to the UE. For SCG bearers (e.g., the right bearer in FIG. 3), the SeNB is directly connected with the S-GW via an S1-U interface.

Signaling radio bearers (SRB) are typically of the MCG bearer type and, therefore, use radio resources provided by the MeNB. At least one cell in SCG typically has a configured UL RRC connection, and one of them is configured with PUCCH resources, which may be used for control procedures (e.g., data scheduling) that do not require the existence of an SRB. As noted above, re-establishment may be triggered when the PCell experiences RLF, but not when an SCell experiences RLF. The MeNB maintains the radio resource management (RRM) measurement configuration of the UE and may decide to request an SeNB to provide additional resources (serving cells) for a UE (e.g., based on received measurement reports or traffic conditions or bearer types). In this case, the MeNB and the SeNB may exchange information about UE configuration by means of RRC containers (inter-node messages) carried in X2 messages. In DC, two cell radio network temporary identifiers (C-RNTI) are typically independently allocated to a UE, one for use in communicating with the MCG, and one for use in communicating with the SCG.

### Example User Plane Offload Options

As used herein, the term offload generally refers to the breaking out (i.e., offloading) of data at an earlier point in the path. For example, if data is routed from one path (e.g., through an MeNB and an SeNB) to a shorter path (e.g, through an SeNB only), then the data is said to be offloaded. For example, a UE may be said to be operating with minimal offload for a flow, if all data is routed through a GW in the CN via an MeNB. The UE may be said to be operating with local offload for a flow, if all data is routed through a LGW in the MeNB while the UE may be said to be operating with maximum offload for the flow if all the data is routed through a LGW in the SeNB and does not traverse the MeNB.

As used herein, the term User plane (U-plane) splitting generally refers to how the traffic is delivered from the GW to the UE. As will be described in greater detail below, decisions regarding where to offload traffic and how to configure U-plane splitting may be based on the data service requirements and other considerations (e.g., available resources and radio frequency (RF) conditions of potential offload targets).

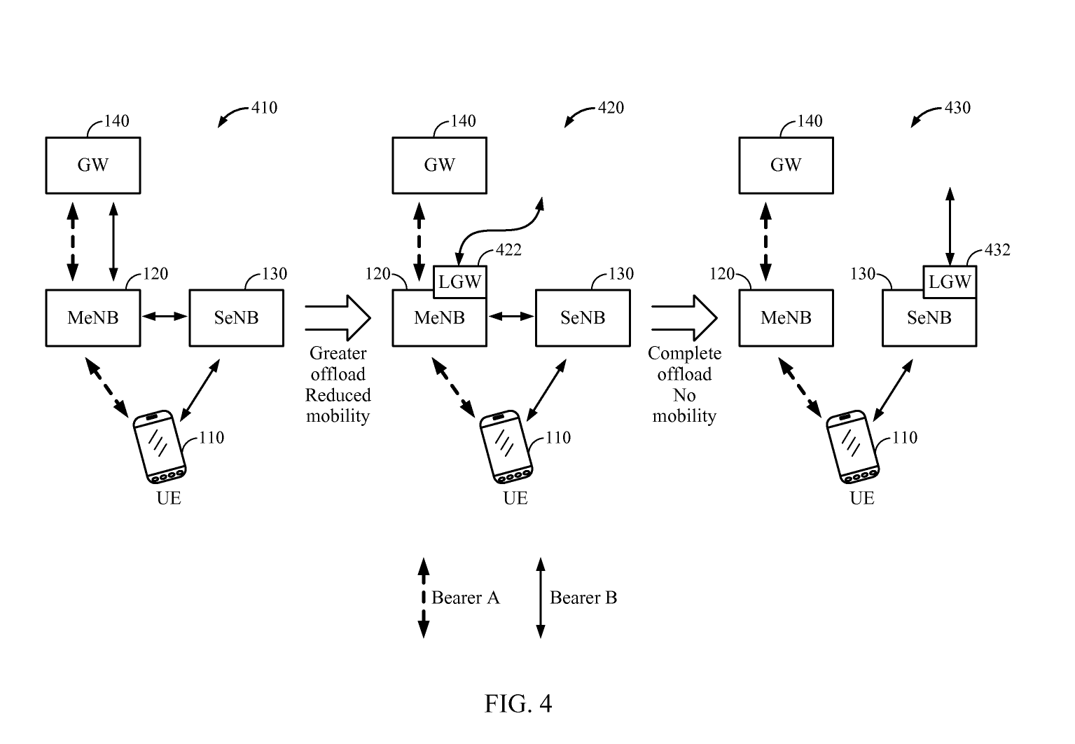

FIG. 4 illustrates various U-plane offload options. In a first configuration 410, the GW 140 for U-plane data, such as operator services and voice over LTE (VoLTE), may be in the core network (CN). In the first configuration, the U-plane data may be described as minimally offloaded (from the perspective of the core network), because the common gateway 140 is upstream of the MeNB and SeNB.

In a second configuration 420, the GW may be at the MeNB (shown as local or logical gateway LGW) for traffic requiring “local” session continuity within the service area of the MeNB, such as selected internet IP traffic offload (SIPTO) at the RAN. In the second configuration, the “local” session traffic may be described as being in a greater offload (e.g., more offloaded) than the traffic in the first configuration because the local gateway 422 is located at the MeNB, meaning that data handling (e.g., routing) for such traffic can take place at the MeNB rather than at nodes in the core network.

In a third configuration 430, the LGW 432 is at the SeNB for non-seamless traffic (e.g., SIPTO at a local network). In the third configuration, the non-seamless traffic may be described as completely (or maximally) offloaded, as the gateway is located at the SeNB, and thus none of the traffic traverses the MeNB or the network operator gateway. Mobility for the services provided to the UE decreases as the offload increases, because mobility (e.g., handovers) are managed by the MeNB, but the offloaded traffic is traversing and even being managed by the SeNB.

Decisions on where and how to offload data may have significant impacts on performance and implementation complexity. For example, data offload in the RAN may reduce overall U-plane traffic at the CN and enable efficient access to local services. However, this same offload may impact user experience for highly mobile UEs due to the need to relocate or modify the gateway functionality if the UE changes cells, and may also increase backhaul connectivity requirements for data forwarding between cells for local session continuity.

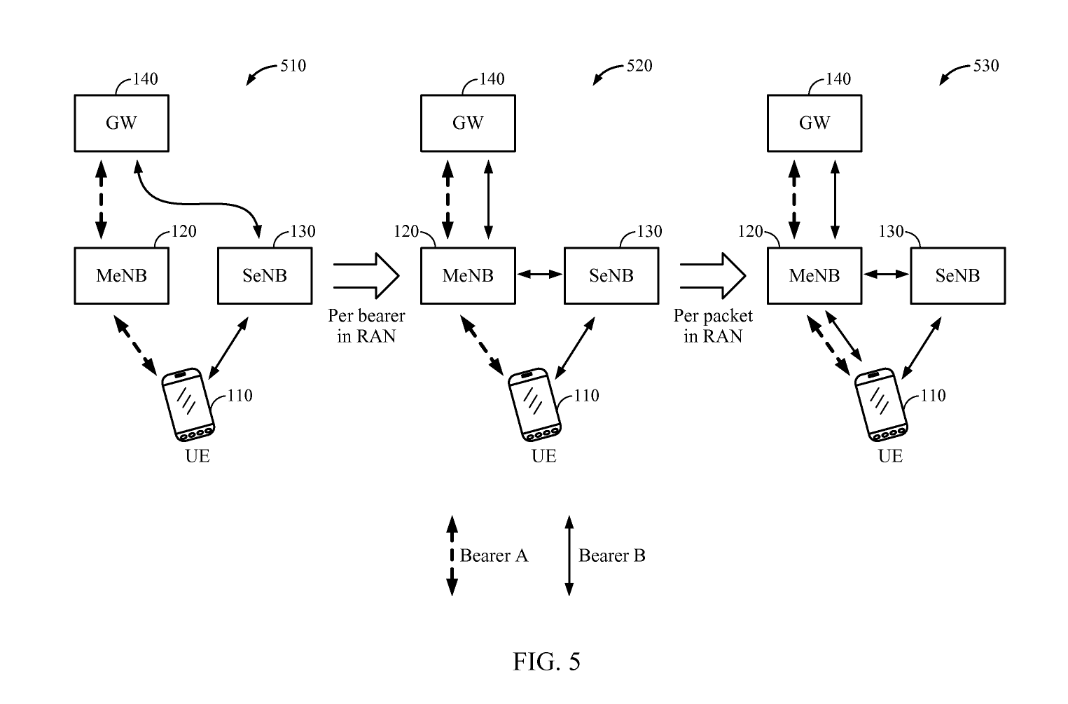

FIG. 5 illustrates three example U-plane splitting options. U-plane splitting configurations generally define how and where bearers are served by the network and UE for seamless connectivity. Decisions regarding whether U-plane data is split on a per-packet basis (packet splitting) or a per-bearer basis (bearer splitting) may be based on coupling between the MeNB and SeNB. In addition, the decisions may be a function of UE capability and backhaul availability

As illustrated, in a first configuration 510, U-plane data may be routed to or from the core network GW 140 via the SeNB 130. This is an example of bearer splitting in the core network.

A second configuration 520 shows per-bearer U-plane splitting (or simply bearer splitting) in the RAN. That is, the packets are routed based on which bearer each packet is for by the core network in configuration 510 and by the RAN in configuration 520.

A third configuration 530 shows per-packet U-plane splitting (or simply packet splitting) in the RAN. As illustrated, in this configuration, some packets for a bearer are served by the MeNB while other packets are served by the SeNB.

For bearer splitting, there may be no need to route, process and buffer bearer traffic served by the SeNB at the MeNB. As a result, there is no need to route all traffic to the MeNB, which may allow for less stringent requirements on the backhaul link between the MeNB and the SeNB (e.g., less bandwidth demands and higher latency tolerated). In addition, bearer splitting may provide support of SIPTO and content caching at the SeNB, as well as independent protocol stacks on each link as there is no requirement for coordinated flow control between the two links.

In some cases, packet splitting may have advantages over bearer splitting. For example, for bearer splitting the offloading may need to be performed by a mobility management entity (MME) configuring the tunnels (e.g., IPSec tunnels or other protocol tunnels) at the SGW and, as a result, dynamic changes to the configuration of bearers may be limited and may require SeNB mobility to be visible to the CN. That is, if a UE moves out of the service area (e.g., a cell) of an SeNB, the CN must be informed so that the CN can reconfigure the bearers for the UE. For bearers handled by the SeNB, handover-like interruption may occur with SeNB changes, with data forwarding between SeNBs. Further, utilization of radio resources across an MeNB and an SeNB for the same bearer may not be possible in many cases.

Packet splitting may enable CA-like gains across cells and fine granularity load balancing (as routing decisions are made per-packet rather than per-bearer). Packet splitting may also enable more dynamic bearer switching based on cell loading and may also reduce CN signaling as SeNB mobility may be partly or entirely hidden from the CN. That is, the CN may not be informed of a UE moving out of a service area of a particular SeNB, as the CN forwards the packets to the RAN, and the RAN determines which SeNB (or the MeNB) delivers the packet to the UE. Further, as routing decisions are made per-packet, no data forwarding between SeNBs may be required upon a change of the SeNB (e.g., when changing SeNBs, packets may simply not be routed to an SeNB being de-activated), thus relaxing requirements for SeNB mobility. In addition, utilization of radio resources across MeNB and SeNB for the same bearer may be possible.

In some cases, bearer splitting may have advantages over packet splitting. For example, packet splitting may require routing, processing and buffering all traffic in the MeNB and may also increase backhaul connectivity requirements, relative to bearer splitting, for data forwarding between cells, and packet splitting does not readily support SIPTO or content caching at the SeNB. In addition, packet splitting may require coordinated flow control and may result in more complex protocol stacks (relative to bearer splitting) to account for different links and over the air (OTA) and backhaul latencies.

### Example Control Plane Options

Various RRC functions may be relevant for the SeNB operation used in MC routing. For example, common radio resource configurations of an SeNB, dedicated radio resource configurations, and measurement and mobility control for the SeNB, may be relevant to MC routing.

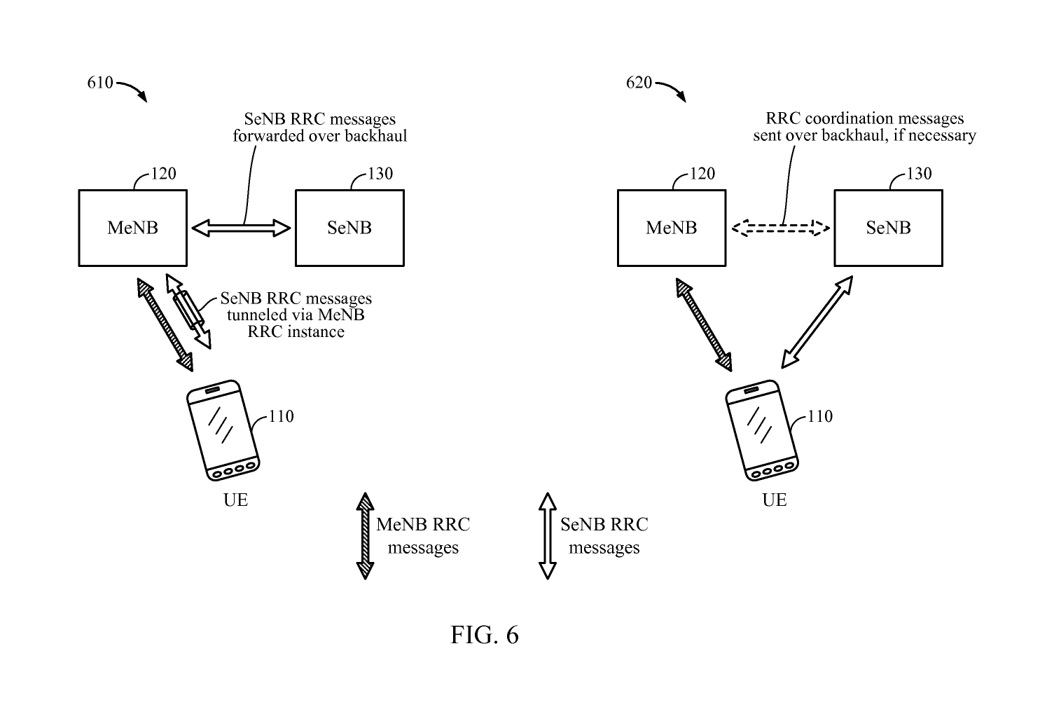

FIG. 6 illustrates example control plane logical architecture options for RRC. In some cases, the RRC packets for the MeNB 120 may be sent to the MeNB via the SeNB 130 and forwarded over the backhaul (configuration 620) and/or vice versa (configuration 610). In this case, the RRC messaging (or other RAT equivalent signaling) may need to support an address scheme over the air (OTA) to identify the target (whether MeNB or SeNB) for the packet.

As illustrated by configuration 610, the RRC logical architecture may include a single RRC instance in an MeNB, wherein any RRC messages delivered via an SeNB are tunneled via the MeNB RRC instance. As illustrated by configuration 620, the RRC logical architecture may also include separate RRC (or equivalent) instances in the MeNB and the SeNB, for example, with the separate independent instances managing the air link configuration. In this case, coordination over X2 may be needed for UE configuration, for example, the MeNB and SeNB may coordinate to assign common or mutually compatible discontinuous reception (DRX) parameters to the UE.

In some cases, the RRC functionality allowed in the SeNB may only be a subset of the full RRC functionality (e.g., if only the MeNB manages mobility of the UE in connecting to the SeNB and U-plane splitting configuration). In this case, the RRC instance in the MeNB may be considered a primary RRC and the RRC instance in the SeNB may be considered a secondary RRC. In some cases, the SeNB may be associated with a different RAT as compared to the MeNB, which may be similar to having separate systems as there may be no requirement for the MeNB to manage the configuration of the SeNB air link to the UE.

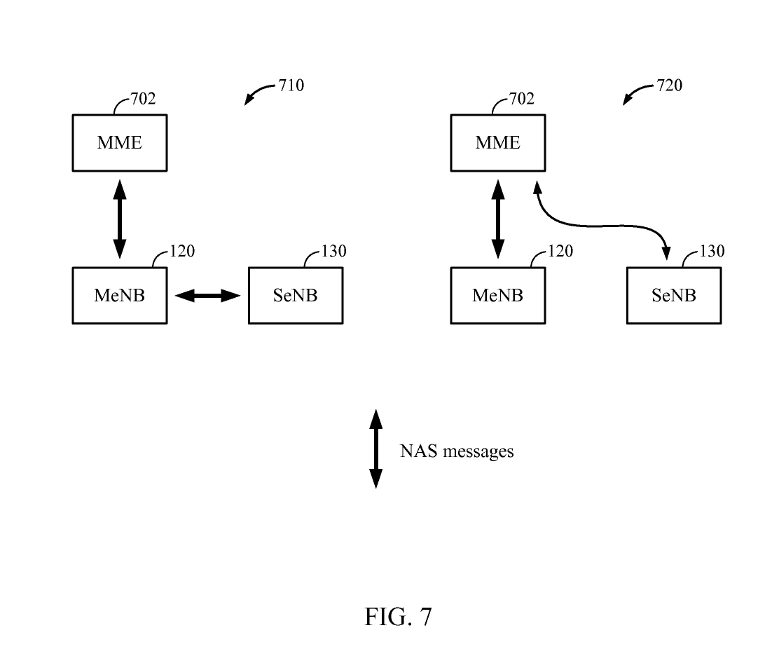

FIG. 7 illustrates C-plane NAS logical architecture options. The NAS logical architecture options include a single NAS instance in an MME 702, served by lower layer transport through a single MeNB 120 as illustrated by configuration 710. The protocol stack in the MeNB provides transport for NAS messages exchanged by the UE with the MME. In this logical architecture, NAS messages may or may not be sent through the SeNB 130, depending on the RRC logical architecture used with the NAS architecture. NAS messages to be sent through the SeNB are forwarded to the SeNB from the MeNB (for delivery from the MME to the UE), or forwarded to the MeNB from the SeNB (in case of delivery from the UE to the MME).

A second C-plane NAS logical architecture option is to include an independent instance in each of the MeNB and the SeNB of a protocol layer capable of delivering messages to a NAS instance in the MME (e.g., an RRC layer), as illustrated by configuration 720. In the second NAS architecture, the MME 702 exchanges NAS messages via both the MeNB 120 and the SeNB 130. In such an architecture the MME may operate a single NAS protocol instance with the ability to coordinate separate communications with the SeNB and the MeNB. The protocol layer implemented in the SeNB for communication with the NAS layer in the MME may comprise only a subset of the underlying protocol; e.g., an RRC layer in the SeNB may not support all functions of a complete RRC instance, as described further below.

A particular example implementation of a C-plane NAS and RRC logical architecture may have separate RRC (or equivalent) instances in an MeNB and an SeNB with a single NAS in the MeNB. The separate RRC instances may require some coordination over X2 for dedicated and common resources in order to serve the UE, although this coordination may be invisible to the UE. As noted above, the RRC instance in the SeNB may only be a subset of a full RRC (e.g., the RRC of the MeNB may act as a primary RRC which manages mobility of the UE to the SeNB and U-plane splitting configuration, and the RRC of the SeNB may act as a secondary RRC with limited functionality, such as having only the ability to provide transport for NAS messages without supporting the mobility and resource management functions that would normally be present in a fully implemented RRC protocol instance). NAS messages from the single NAS instance in the MeNB may be sent to either the MeNB or the SeNB. A new procedure may be used to reconfigure the SeNB to function as an MeNB for a particular UE, for example, as a “failover” mechanism in the case of RLF on the MeNB.

### Example Control Plane Mobility

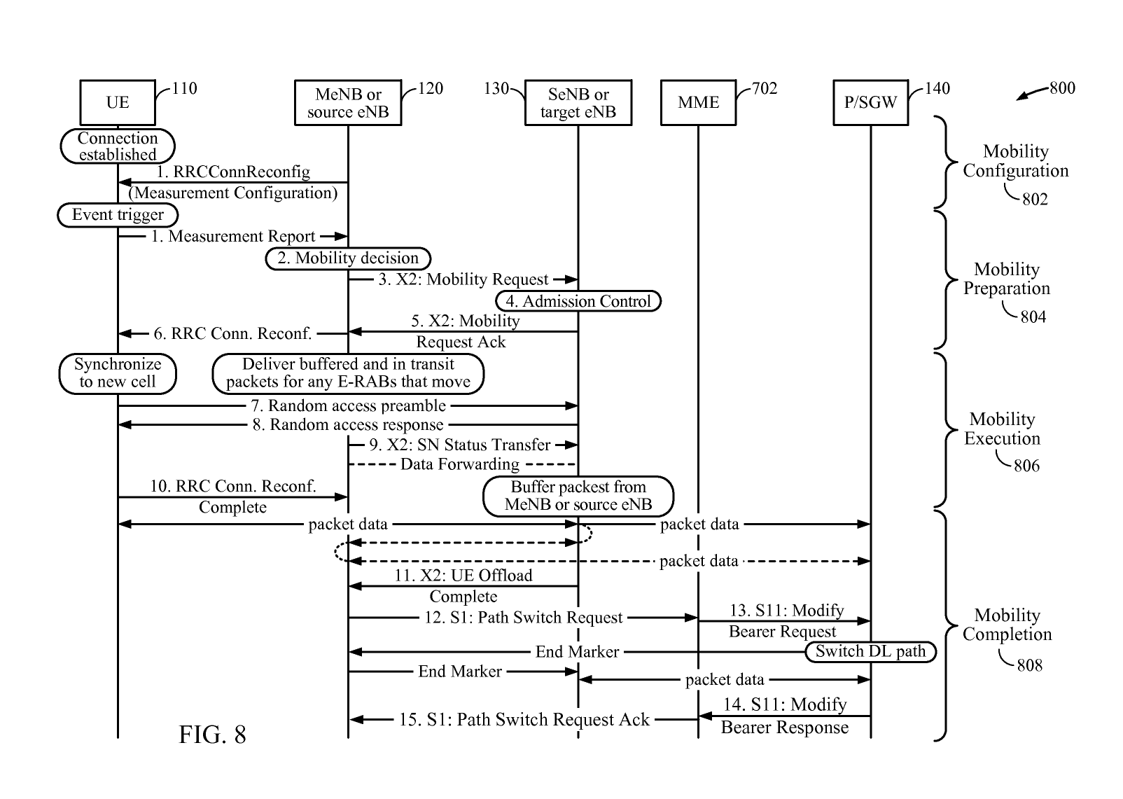

FIG. 8 illustrates an example call flow diagram 800 for a C-plane mobility procedure, where a DC data path is shown as a dashed line for PDCP aggregation. As illustrated, the C-plane mobility procedure may occur in four general phases. The four phases apply for mobility during both handover and multi connectivity. The four phases may include a UE mobility configuration phase 802, a RAN mobility preparation phase 804, a mobility execution phase 806, and a mobility completion phase 808.

The UE mobility configuration phase 802 begins with, for example, the UE establishing a connection and receiving, from the MeNB, a measurement configuration. UE mobility configuration allows the RAN to configure the UE to set the RF triggers for mobility. This includes the RF conditions on the serving cell, neighbor cells (both intra and inter RAT), and relative conditions between the serving and neighbor cells. The UE mobility configuration includes service and context aware events. For example, based on a specific traffic type, the UE may perform measurements on frequencies or other resources to trigger mobility events to RATs or channel resources specific to a certain type of traffic (e.g., a type defined by latency or other QoS aspects, low power requirements for the UE, or a content type, e.g., Multimedia Broadcast Multicast Service (MBMS)). In certain aspects, the network may provide configuration, including context and service configuration, for a UE to determine when to perform HO measurements (UE-centric measurement triggering). In other aspects, the UE provides context and service state to the network, and the network triggers measurement events based on the state (network-centric measurement triggering). Both UE- and network-centric measurement triggering may be in use in a single system, e.g., for different event types.

During the RAN mobility preparation phase 804, the UE context is provided to the SeNB or a target eNB. For example, the UE sends a measurement report to the MeNB, which makes a mobility decision based on the measurement report. The MeNB then, for example, sends a mobility request via the X2 connection to the target eNB (the prospective SeNB) to perform admission control. For backward HO, the UE context is sent to the target eNB before the HO or DC event, for example, triggered based on the UE measurement report in response to the mobility configuration. For forward HO, the context is sent after the HO event, i.e., sending the context is triggered as a pull from the target eNB in response to the UE establishing a connection at the target eNB and identifying the source eNB. The backward-HO approach would typically be expected for multi-connectivity mobility events, but the forward-HO approach is also possible, Sending the context after the HO or DC event (the forward-HO model) may provide a potential for more efficient preparation of multiple target eNBs, when compared to sending the context before the HO event. Moreover, sending the context after the HO or DC event may allow for differentiation between handovers within a cloud or cluster and handovers to a BS outside the cloud or cluster. For example, for intra cloud handover, coordinated multipoint (CoMP) concepts may be extended to provide a single logical context across the cloud that does not change when the point of attachment changes, and actual HO (e.g., transferring the control-plane function for the UE from one eNB to another) may only be needed for inter cloud UE mobility.

During the mobility execution phase 806, the UE may establish a connection at the SeNB or target eNB. The newly established connection allows UL and DL data to be communicated via the SeNB or target eNB. For example, the SeNB sends a mobility request acknowledgement via the X2 connection to the MeNB. The MeNB then sends an RRC connection reconfiguration message to the UE. The UE then synchronizes to the new cell, sends a random access preamble to the SeNB, and receives a random access response from the SeNB. The MeNB then sends the sequence number (SN) status transfer message to the SeNB and begins data forwarding. This approach may provide the potential to perform an inter-cluster HO while maintaining IP connections via selected IP traffic offload (SIPTO) and local IP access (LIPA). In addition, this approach may allow optimized procedures to assign a new IP address on HO, as well as enabling more make before break (as compared to current HO techniques) for mission critical applications, due to multi connectivity. MPTCP can be used (e.g., end-to-end) if required, or applications can be multi-homed or designed to handle IP address changes.

During the mobility completion phase 808, the network moves any tunnels associated with the SeNB or target eNB and the SGW to point directly to the SeNB or target eNB and in the case of HO, releases resources on the source eNB.

### Example Inter/Intra Radio Access Technology Mobility and User-Plane Split Measurement Configuration

As noted above, as a part of managing UE connectivity to the RAN, an MeNB may make decisions for the UE regarding aggregation and U-plane splitting options. For example, the MeNB may decide to configure one or more of aggregation within a node (e.g., carrier aggregation). The MeNB may also decide to split a U-plane across nodes via the RAN (e.g., multi connectivity) using, for example, packet splitting or bearer splitting over an X2 connection instead of an S1 connection. The MeNB may also decide to split a U-plane across nodes via the core network (e.g., multi connectivity) using a bearer split.

The MeNB may also configure non-seamless offload (e.g., including offload to another operator), if a lack of session continuity is allowed. In some cases, the MeNB may configure bi-casting traffic, for example, with each packet served by both the MeNB and SeNB for greater reliability/robustness.

In addition, the MeNB may also have to make handover (HO) decisions, such as determining whether to perform HO of the UE. For example, the MeNB may determine whether to actually change the MeNB for the UE instead of simply applying one of the aggregation and U-plane split options and/or activate, deactivate or change the current SeNB for the UE in the case of multi connectivity. These decisions may be based on various criteria including information measured by the UE, bearer and traffic characteristics, and information about the current and/or potential SeNBs.

In order to manage the UE connectivity, the MeNB may configure the UE using dedicated signaling (e.g., using an RRCConnectionReconfiguration message). Dedicated signaling may be used to report measurement information according to the measurement configuration provided to the UE from the MeNB. The measurement configuration generally instructs the UE to report parameters that may help the MeNB in deciding among aggregation and U-plane split options, as well as the mobility of the UE to the SeNB. The measurement configuration may include options that extend the reporting to multiple RATs, for example, with an MeNB in a 3GPP RAT such as LTE, and one or more SeNBs in a different RAT such as WLAN or mmW.

In this manner, the MeNB may consider more factors (than conventional eNBs) in determining which measurements to configure on the UE for reporting. For example, in order to extend these measurement procedures to other RATs, the MeNB may consider the type of RAT(s) being used (and the MeNB's role in interworking with the other RAT(s)) in order to correctly configure the measurements. A certain configuration may be chosen, for example, when the MeNB only determines the aggregation and U-plane split while leaving other entities, e.g. within the network managing the other RAT, to determine the best SeNB to use with the RAT.

Aspects of the present disclosure provide techniques that may assist an MeNB in making decisions regarding mobility, aggregation, and U-plane splitting for a MC UE. For example, the techniques allow the MeNB to consider which functionality it is managing towards an SeNB. This allows the MeNB to determine the type of feedback for the UE to report when determining the aggregation, U-plane splitting options, and mobility for the UE, potentially across multiple RATs.

Various types of feedback may be categorized based on how the information may be used. For example, the types of feedback may be categorized based on the decisions of the MeNB in which the information may be used. In certain aspects, feedback may be categorized as aggregation and U-plane split feedback and MeNB and SeNB mobility feedback.

For aggregation and U-plane split, the feedback used to determine the aggregation and U-plane split may be primarily directed to providing information about a current or potential SCC or SeNB. For example, in MC, the MeNB may change the U-plane split based on the current RF and load conditions at the SeNB. For example, the UE may be configured to provide information on the RF and/or load conditions at the serving SeNB, which the MeNB can use to determine the bearer configuration on the MeNB and SeNB. Alternatively, some or all of this information may be exchanged between the MeNB and SeNB over the backhaul, potentially in response to information indicated by the UE.

For MeNB and SeNB mobility, the feedback used to determine the mobility may be primarily directed to providing information about the MeNB or SeNB and additional candidate MeNBs or SeNBs, respectively, for both intra-RAT and inter-RAT HO of the MeNB and/or SeNB. For example, such feedback may include RF and/or load conditions for different candidate MeNBs and/or SeNBs for HO and MC, respectively. The MeNB may use this information to determine the best SeNB to use for MC or when to HO the MeNB.

In some cases, the UE mobility within or towards a particular RAT is managed by the MeNB. For example, the MeNB may manage when to activate and deactivate MC to WLAN, but not control inter-SeNB mobility among WLAN APs. Inter WLAN AP mobility (between APs within a WLAN) may use an intra-WLAN procedure managed by the UE, the WLAN APs, or a WLAN AP controller. In some cases, a UE-implementation- or network-based intra-WLAN mobility procedure may be used to determine where to connect among different WLAN APs. In addition, within a RAT such as WLAN, the MeNB may manage mobility within some set of WLAN APs, but not others. For example, the MeNB may manage inter-WLAN-AP mobility for the case of a U-plane split via the RAN to WLAN, but not the inter-WLAN-AP mobility for a U-plane split via the CN or for non-seamless offload. In these scenarios, the MeNB and SeNB mobility may only determine when to perform HO or MC towards the SeNB RAT, but not the actual serving SeNB(s) within the RAT.

To accommodate these and other scenarios, when the MeNB configures the UE using dedicated signaling and reports measurement information, the MeNB may need to consider the RAT type and other information (potentially information specific to the RAT type, e.g., comparative quality measurements of access points based on criteria for the particular RAT) to determine which types of configuration to provide to the UE.

In making these decisions, the MeNB may first determine which combinations of aggregation and U-plane split for the UE are available. The MeNB may use UE subscription and policy to, for example, determine which combinations the UE is permitted to use based on the current subscription. For example, a UE may not have a WLAN subscription with the operator network. The UE capability may be used to determine which combinations are available at the UE. The capabilities may be dynamic, for example, if the WLAN radio is available for multi-connectivity or it is being used for a user preferred AP. In the latter case the UE might indicate non-availability of its WLAN capabilities for MC.

The MeNB may also use UE context to determine what routing (aggregation and/or UE splitting options) are available. Possible contexts include physical mobility (for example, car, train, bike, plane, pedestrian, or stationary), location (including outdoors or indoors, at work or home, in a meeting, in a conference), accessibility and UE state, (for example, on the user's body, separate from the user such as for charging, screen on/off, in holster pocket, active use). A UE that is stationary may be more suitable for certain RATs, such as WLAN or mmW due for example to a lack of mobility support available in the RAT. Geographic location, such as a position obtained from a location service (LCS) or via sensors in the UE, may also provide the MeNB with information regarding collocated or nearby nodes or networks that may be candidates for use in an MC configuration.

The MeNB may also use UE services in making routing decisions. For example, the MeNB may consider which services have active traffic being exchanged on the network, including current or anticipated amount of traffic and types of active services. Some services may not be suitable for certain RATs (e.g., mission critical services may not be suitable on a mmW RAT due to low reliability of the connection). In some cases, services may be detected based on backhaul feedback from another cell/RAT or from serving nodes in an operator's network, e.g., an application gateway. Services may also be detected by OTA messages, such as the UE activating a service by establishing a PDN connection or bearer for the service, or indicating the service in RRC, or through the network detecting (e.g., due to deep packet inspection-DPI) bearer information that a new service may be activated. This detection may also include services that may not be directly visible to the network, such as services active in the operator network that are being non-seamlessly offloaded to WLAN which may, for example, be reported by the UE in RRC or NAS as part of the configuration.

The MeNB may then determine a set of RATs which are suitable in the coverage of the MeNB for the determined aggregation and U-plane split combination. The determination may be based on a combination of various factors. Such factors may include, for example, MeNB knowledge of the UE location within the cell (e.g., whether the MeNB knows the location of the UE and the location of one or more potential other cells within the UE coverage). The factors may also include MeNB learning based on the history of the MeNB with the UE or other served UEs. For example, the MeNB may correlate UE measurement reporting or previous UE information with respect to the existing location of one or more potential cells. The factors may also include UE subscription and policy or services and context similar to the service and context used in the determination of the aggregation and U-plane split combination, as described above.

The MeNB may then configure different types of feedback to provide for the UE, based on the set of RATs and the aggregation and U-plane split combination. As described above, the different types of feedback may include U-plane split feedback (for example, RF conditions and throughput information to determine which traffic to route on the SeNB), as well as activation (for example, which radios in the UE are turned on and available for use) and mobility feedback (for example, RF conditions for different candidate SeNBs to determine which one to use as a potential target for mobility).

As described above, managing data routing in an MC environment may involve coordinated operations performed at both the MeNB and the UE, for example, to provide information to the MeNB to help make data routing decisions.

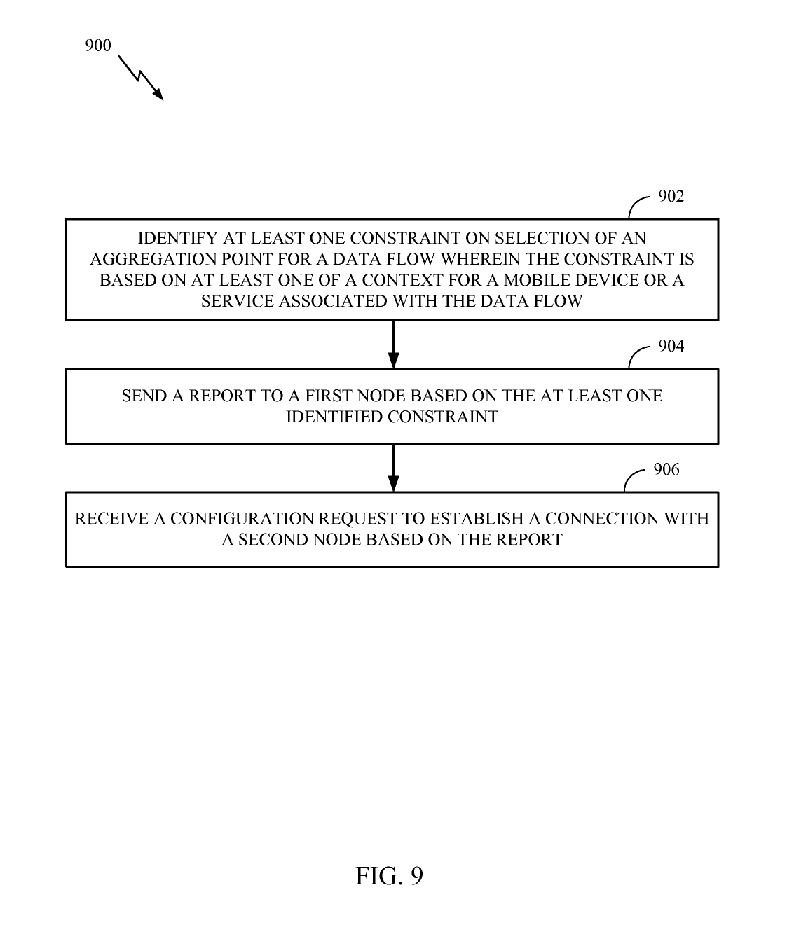

FIG. 9 illustrates example operations 900 for managing at least one data flow between a core network and a mobile device, in accordance with aspects of the present disclosure. The operations 900 may be performed, for example, by a mobile device.

The operations 900 begin, at 902, by identifying at least one constraint on a selection of an aggregation point for the at least one data flow, wherein the at least one constraint is based at least in part on at least one context for the mobile device or at least one service associated with the data flow. At 904, the mobile device sends a report to a first node based on the at least one identified constraint. At 906, the mobile device receives a configuration request to establish a connection with a second node based on the report.

In some cases, the report may comprise the one or more identified constraints, which may be based on capabilities of the UE. Further, the report may indicate at least one suggested aggregation point (e.g., an eNB, SGW, or application end-point (e.g., a separate IP interface)) based at least in part on the one or more constraints. In some cases, the UE may determine the at least one suggested aggregation point from the one or more constraints based on a policy (e.g., the UE may have a policy associating data flows with a list of one or more preferred aggregation points or forbidden aggregation points). In some cases, the connection with the second node may comprise a handover or MC connection.

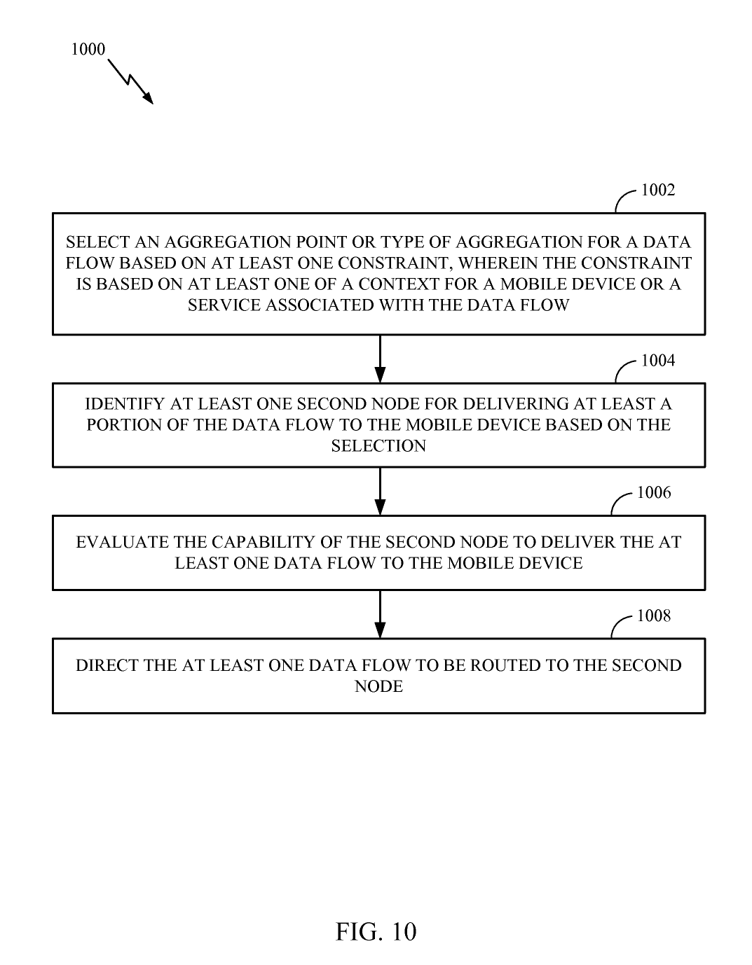

FIG. 10 illustrates example operations 1000 for managing at least one data flow between a core network and a mobile device, in accordance with aspects of the present disclosure. The operations 1000 may be performed, for example, by a first node or base station, such as an MeNB.

The operations 1000 begin, at 1002, by the first node (e.g., an MeNB) selecting an aggregation point or type for the at least one data flow based on at least one constraint. At 1004, the first node identifies at least one second node (e.g., an SeNB) to consider for delivering the at least one data flow to the mobile device based on the selection of the aggregation point. At 1006, the first node evaluates the capability of the second node to deliver the at least one data flow to the mobile device. At 1008, the first directs the one or more data flow to be routed to the second node.

In certain aspects, the at least one constraint is based at least in part on at least one context for the mobile device or at least one service associated with the data flow. In some cases, the second node may be configured to manage the at least one data flow according to a plurality of layers in a protocol stack that are below a layer that is determined based on a selection of a flow split or a packet split at the aggregation point.

In some cases, the first node (e.g., MeNB) may select a flow split or a packet split at the aggregation point. In some cases, identifying one or more constraints on the selection of an aggregation point may take into consideration various constraints, such as a constraint based on the UE subscription and policy, a constraint based on the UE capabilities, a constraint based on the UE context, and/or which services have active traffic being exchanged on the network.

In some cases, evaluating the capability of the second node to deliver the one or more data flows to the mobile device may involve various considerations, such as whether the first node and the second node operate according to distinct radio access technologies (RATs), a quality of service (QoS) contract, availability of radio resources at the second node, the available capacity and latency of a backhaul connection between the first node and second node, an indication by the mobile device of information related to radio conditions, one or more indicated capabilities of the mobile device, and/or an estimate of the geographic position of the mobile device.

In some cases, the first node may configure the mobile device to report to the first node information related to the delivery from the second node of the one or more data flows (e.g., measurement configuration for a foreign RAT). In some cases, the configuration may be for the mobile device to report feedback to support the selection of candidate aggregation points (e.g., RF conditions and throughput information for SeNB). In some cases, the configuration may be for the mobile device to report feedback to support the selection of the SeNB (e.g., RF conditions for different candidate secondary eNBs to determine which one to use for mobility).

In some cases, determining the capability of the second node to deliver the one or more data flows to the mobile device may involve sending an admission request to the second node.

In some cases, the first node may perform operations 1000 responsive to a request to establish (e.g., configure) one or more new data flows (e.g., split selection at service establishment), responsive to a request to modify one or more existing data flows (reconfiguration), or responsive to evaluation of one or more existing data flows for relocation to a new serving node. For example, for mobility, a data flow may be split into flows from the MeNB to SeNB (MeNB=>SeNB) and from one SeNB to another (SeNB=>SeNB), which may also be done for load balancing.

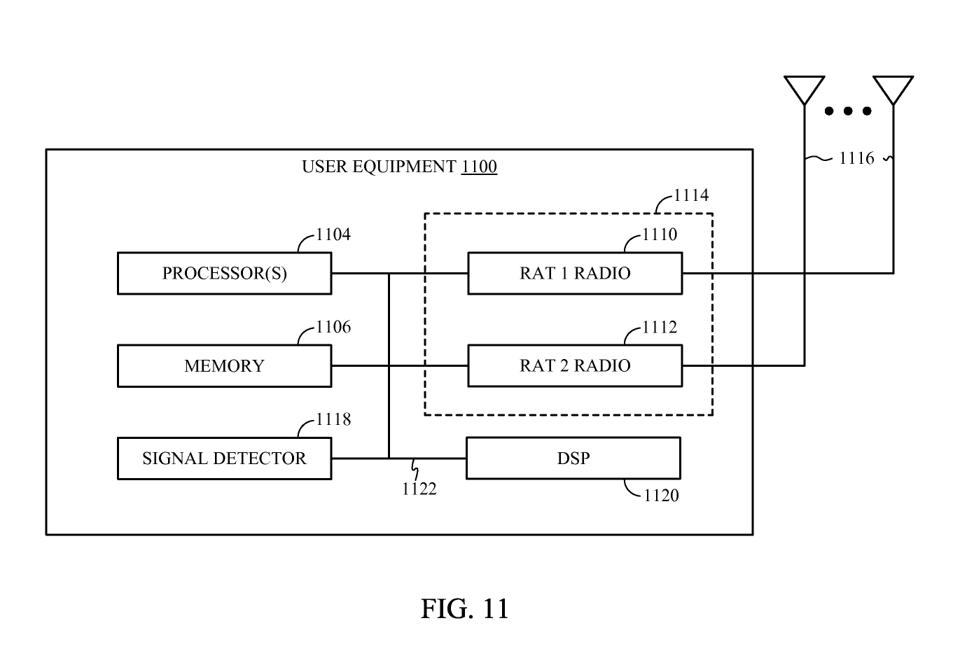

FIG. 11 illustrates various components that may be utilized in a MC enabled wireless device 1100 capable of operating in accordance with aspects provided herein. The wireless device 1100 may, for example, be one implementation of UE 110 shown in FIG. 1.

The wireless device 1100 may include one or more processors 1104 which control operation of the wireless device 1100. The processors 1104 may also be referred to as central processing units (CPUs). The processors 1104 may perform, or direct the wireless device 1100 in managing data flows, as described above with reference to FIG. 9. Memory 1106, which may include both read-only memory (ROM) and random access memory (RAM), provides instructions and data to the processors 1104. A portion of the memory 1106 may also include non-volatile random access memory (NVRAM). The processors 1104 typically perform logical and arithmetic operations based on program instructions stored within the memory 1106. The instructions in the memory 1106 may be executable to implement the methods described herein, such as managing data flows as described above with respect to FIG. 9.

The wireless device 1100 may also include radios 1110 and 1112 to communicate via multiple RATs for MC. Each radio may, for example, include a transmitter and receiver, and any other “RF chain” components to allow transmission and reception of data between the wireless device 1100 and different RATs. While two radios are shown for two RATs, as an example only, more than two radios may be included (e.g., to support more than two RATs). Each radio may communicate via a single or a plurality of antennas 1116.

The wireless device 1100 may also include a signal detector 1118 that may be used in an effort to detect and quantify the level of signals received by the transceiver 1114. The signal detector 1118 may detect such signals as total energy, energy per subcarrier per symbol, power spectral density and other signals. The wireless device 1100 may also include a digital signal processor (DSP) 1120 for use in processing signals.

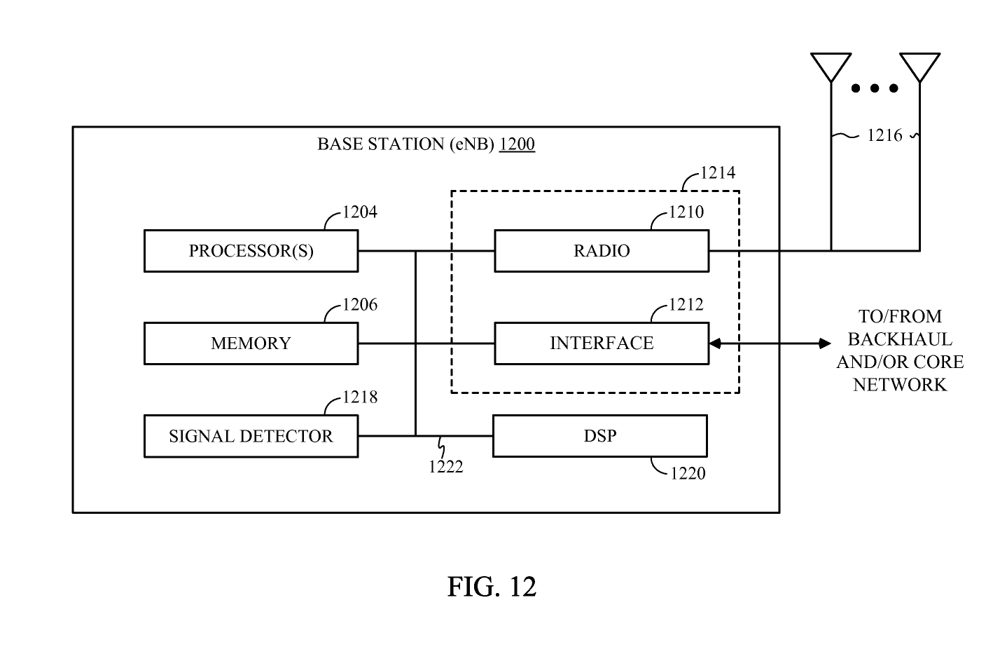

FIG. 12 illustrates various components that may be utilized in a base station 1200 capable of participating in communication with a MC enabled wireless device. The base station 1200 may, for example, be one implementation of MeNB 120 or SeNB 130 shown in FIG. 1.

The base station 1200 may include one or more processors 1204 which control operation of the base station 1200. The processors 1204 may also be referred to as central processing units (CPUs). The processors 1204 may perform, or direct the base station 1200 in managing data flows, as described above with reference to FIG. 10. Memory 1206, which may include both read-only memory (ROM) and random access memory (RAM), provides instructions and data to the processors 1204. A portion of the memory 1206 may also include non-volatile random access memory (NVRAM). The processors 1204 typically perform logical and arithmetic operations based on program instructions stored within the memory 1206. The instructions in the memory 1206 may be executable to implement the methods described herein (e.g., for MeNBs and SeNBs serving a DC UE) such as managing data flows, as described above with reference to FIG. 10.

The base station 1200 may also include one or more radios 1210, for example to communicate with a UE via one or more RATs. Each radio may, for example, include a transmitter and receiver, and any other “RF chain” components to allow transmission and reception of data between the base station 1200 and different UEs. Each radio may communicate via a single or a plurality of antennas 1216. The base station 1200 may also include an interface 1212 for communicating with other base stations (e.g., via an X2 backhaul connection) or a core network (e.g., via an S1 connection).

The base station 1200 may also include a signal detector 1218 that may be used in an effort to detect and quantify the level of signals received by the transceiver 1214. The signal detector 1218 may detect such signals as total energy, energy per subcarrier per symbol, power spectral density and other signals. The base station 1200 may also include a digital signal processor (DSP) 1220 for use in processing signals.

It is understood that the specific order or hierarchy of steps in the processes disclosed above is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication by a mobile device for managing at least one data flow between a core network and the mobile device comprising:
identifying at least one constraint on selection of an aggregation point for the data flow wherein the constraint is based on at least one of a context for the mobile device or a service associated with the data flow;
sending a report to a first node based on the at least one identified constraint; and
receiving a configuration request to establish a connection with a second node based on the report.

2. The method of claim 1, wherein the report comprises an indication of the identified constraint.

3. The method of claim 1, wherein the report indicates at least one suggested aggregation point based on the constraint.

4. The method of claim 3 further comprising determining the at least one suggested aggregation point from the at least one constraint based on a policy.

5. The method of claim 4, wherein the policy associates data flows with at least one of a preferred aggregation point or a forbidden aggregation point.

6. The method of claim 1, wherein receiving the configuration request to establish the connection with the second node based on the report comprises at least one of:
receiving a request to handover to the second node; or
receiving a request to configure multi-connectivity with the first and second node.

7. The method of claim 1, wherein the constraints are based on capabilities of the mobile device.

8. The method of claim 1, wherein the aggregation point comprises at least one of an eNodeB, a Mobility Management Entity (MME), or a gateway (GW).

9. A method of wireless communication by a first node for managing at least one data flow between a core network and a mobile device comprising:
selecting an aggregation point or type of aggregation for the data flow based on at least one constraint, wherein the constraint is based on at least one of a context for the mobile device or a service associated with the data flow;
identifying at least one second node for delivering at least a portion of the data flow to the mobile device based on the selection;
evaluating a capability of the second node to deliver the at least one data flow to the mobile device; and
directing the at least one data flow to be routed to the second node.

10. The method of claim 9, wherein the second node is configured to manage the data flow according to a plurality of layers in a protocol stack that are below a layer that is determined based on a selection of a packet routing option at the aggregation point.

11. The method of claim 10, wherein the packet routing option comprises at least one of a data flow split or a packet split.

12. The method of claim 10, further comprising selecting the packet routing option.

13. The method of claim 9, wherein the constraint is based on at least one of a subscription and policy of the mobile device, one or more capabilities of the mobile device, a context of the mobile device, or which services have active traffic being exchanged between the core network and the mobile device.

14. The method of claim 9, wherein evaluating the capability of the second node comprises consideration of at least one of:
whether the first node and the second node operate according to distinct radio access technologies (RATs);
a quality of service contract;
availability of radio resources at the second node;
an indication by the mobile device of information related to radio conditions;
one or more indicated capabilities of the mobile device; or
an estimate of a geographic position of the mobile device.

15. The method of claim 9, further comprising configuring the mobile device to report, to the first node, information related to delivery of at least a portion of the data flow from the second node.

16. The method of claim 15, wherein the configuration is for the mobile device to report feedback to support the selection of candidate aggregation points.

17. The method of claim 16, wherein the feedback comprises at least one of radio frequency conditions or throughput information for the second node.

18. The method of claim 15, wherein the configuration is for the mobile device to report feedback to support the selection of the second node.

19. The method of claim 18, wherein the feedback comprises radio frequency conditions for a plurality of candidate second nodes.

20. The method of claim 9, wherein evaluating the capability of the second node to deliver the at least one data flow to the mobile device comprises sending an admission request to the second node.

21. The method of claim 9, wherein the selecting, identifying, and evaluating are performed in response to a request to establish one or more new data flows.

22. The method of claim 9, wherein the selecting, identifying, and evaluating are performed in response to a request to modify one or more existing data flows.

23. The method of claim 9, wherein the selecting, identifying, and evaluating are performed in response to evaluation of one or more existing data flows for relocation to a new serving node.

24. A mobile device for managing at least one data flow between a core network and the mobile device comprising:
means for identifying at least one constraint on selection of an aggregation point for the data flow wherein the constraint is based on at least one of a context for the mobile device or a service associated with the data flow;
means for sending a report to a first node based on the at least one identified constraint; and
means for receiving a configuration request to establish a connection with a second node based on the report.

25. The mobile device of claim 24, wherein the report comprises an indication of the identified constraint.

26. The mobile device of claim 24, wherein the report indicates at least one suggested aggregation point based on the constraint.

27. The mobile device of claim 26 further comprising means for determining the at least one suggested aggregation point from the at least one constraint based on a policy.

28. The mobile device of claim 27, wherein the policy associates data flows with at least one of a preferred aggregation point or a forbidden aggregation point.

29. The mobile device of claim 24, wherein receiving the configuration request to establish the connection with the second node based on the report comprises at least one of:
means for receiving a request to handover to the second node; or
means for receiving a request to configure multi-connectivity with the first and second node.

30. The mobile device of claim 24, wherein the constraints are based on capabilities of the mobile device.

31. The mobile device of claim 24, wherein the aggregation point comprises at least one of an eNodeB, a Mobility Management Entity (MME), or a gateway (GW).

32. A first node for managing at least one data flow between a core network and a mobile device comprising:
means for selecting an aggregation point or type of aggregation for the data flow based on at least one constraint, wherein the constraint is based on at least one of a context for the mobile device or a service associated with the data flow;
means for identifying at least one second node for delivering at least a portion of the data flow to the mobile device based on the selection;
means for evaluating a capability of the second node to deliver the at least one data flow to the mobile device; and
means for directing the at least one data flow to be routed to the second node.

33. The first node of claim 32, wherein the second node is configured to manage the data flow according to a plurality of layers in a protocol stack that are below a layer that is determined based on a selection of a packet routing option at the aggregation point.

34. The first node of claim 33, wherein the packet routing option comprises at least one of a data flow split or a packet split.

35. The first node of claim 33, further comprising means for selecting the packet routing option.

36. The first node of claim 32, wherein the constraint is based on at least one of a subscription and policy of the mobile device, one or more capabilities of the mobile device, a context of the mobile device, or which services have active traffic being exchanged between the core network and the mobile device.

37. The first node of claim 32, wherein means for evaluating the capability of the second node comprises consideration of at least one of:
whether the first node and the second node operate according to distinct radio access technologies (RATs);
a quality of service contract;
availability of radio resources at the second node;
an indication by the mobile device of information related to radio conditions;
one or more indicated capabilities of the mobile device; or
an estimate of a geographic position of the mobile device.

38. The first node of claim 32, further comprising means for configuring the mobile device to report, to the first node, information related to delivery of at least a portion of the data flow from the second node.

39. The first node of claim 38, wherein the configuration is for the mobile device to report feedback to support the selection of candidate aggregation points.

40. The first node of claim 39, wherein the feedback comprises at least one of radio frequency conditions or throughput information for the second node.

41. The first node of claim 38, wherein the configuration is for the mobile device to report feedback to support the selection of the second node.

42. The first node of claim 41, wherein the feedback comprises radio frequency conditions for a plurality of candidate second nodes.

43. The first node of claim 32, wherein means for evaluating the capability of the second node to deliver the at least one data flow to the mobile device comprises means for sending an admission request to the second node.

44. The first node of claim 32, wherein the means for selecting, means for identifying, and means for evaluating are performed in response to a request to establish one or more new data flows.

45. The first node of claim 32, wherein the means for selecting, means for identifying, and means for evaluating are performed in response to a request to modify one or more existing data flows.

46. The first node of claim 32, wherein the means for selecting, means for identifying, and means for evaluating are performed in response to evaluation of one or more existing data flows for relocation to a new serving node.

47. A computer-readable medium for managing at least one data flow between a core network and a mobile device having instructions stored thereon for causing the mobile device to:
identify at least one constraint on selection of an aggregation point for the data flow wherein the constraint is based on at least one of a context for the mobile device or a service associated with the data flow;
send a report to a first node based on the at least one identified constraint; and
receive a configuration request to establish a connection with a second node based on the report.

48. A computer-readable medium for managing at least one data flow between a core network and a mobile device having instructions stored thereon for causing a first node to:
select an aggregation point or type of aggregation for the data flow based on at least one constraint, wherein the constraint is based on at least one of a context for the mobile device or a service associated with the data flow;
identify at least one second node for delivering at least a portion of the data flow to the mobile device based on the selection;
evaluate a capability of the second node to deliver the at least one data flow to the mobile device; and
direct the at least one data flow to be routed to the second node.

49. A mobile device for managing at least one data flow between a core network and the mobile device comprising:
a processing system configured to identify at least one constraint on selection of an aggregation point for the data flow wherein the constraint is based on at least one of a context for the mobile device or a service associated with the data flow;
a transmitter configured to send a report to a first node based on the at least one identified constraint; and
a receiver configured to receive a configuration request to establish a connection with a second node based on the report.

50. A first node for managing at least one data flow between a core network and a mobile device comprising:
a receiver to receive an indication of a capability of a second node; and
a processing system configured to select an aggregation point or type of aggregation for the data flow based on at least one constraint, wherein the constraint is based on at least one of a context for the mobile device or a service associated with the data flow, identify the second node for delivering at least a portion of the data flow to the mobile device based on the selection, evaluate a capability of the second node to deliver the at least one data flow to the mobile device, and direct the at least one data flow to be routed to the second node.
